(19) United States
(12) Patent Application Publication
(10) Pub. No.: US 2019/0213578 A1
(43) Pub. Date: Jul. 11, 2019

(54) VIRTUAL TRANSACTION DEVICE PROVISIONING TO COMPUTING DEVICE

(71) Applicant: Mastercard International Incorporated, Purchase, NY (US)

(72) Inventor: Hugo Reijkens, Den Haag (NL)

(21) Appl. No.: 16/243,497

(22) Filed: Jan. 9, 2019

(30) Foreign Application Priority Data
Jan. 10, 2018 (GB) 1800392.1

(51) Int. Cl. G06Q 20/34; G06Q 20/02; G06Q 20/32

(52) U.S. Cl. CPC G06Q 20/353; G06Q 20/322; G06Q 20/027

(57) ABSTRACT

A method of provisioning a virtual transaction device to a computing device is performed at a computing device. The computing device makes a local wireless connection to a physical transaction device and obtains account identifying information and issuer identifying information from the physical transaction device. The computing device uses the issuer identifying information to connect over a network to a service acting for the issuer to indicate that a virtual transaction device is to be provisioned to the computing device for the account identified by the account identifying information. The computing device then interacts with the service to provision the virtual transaction device to the computing device for the account. A suitable computing device is also described.

### CROSS-REFERENCE TO RELATED APPLICATION

This application is a U.S. National Stage filing under 35 U.S.C. § 119, based on and claiming benefits of and priority to Great Britain Application No. 1800392.1 filed on Jan. 10, 2018. The entire disclosure of the above application is incorporated herein by reference for all purposes.

### TECHNICAL FIELD

The present disclosure relates to provisioning of a virtual transaction device to a computing device. Aspects of the disclosure relate to provisioning of a virtual payment card to a computing device

### BACKGROUND

In many contexts, it is desirable to perform actions entirely in a digital domain between networked computing devices, rather than by using a discrete physical object. In such cases, where control of the physical object is an indication of entitlement to use a service, or is associated with the user's identity in some way, it is desirable for a user to have a computing device that is personal to the user which can be physically controlled in a similar way to the physical object used for that task.

One technical domain where this is relevant is that of transaction devices, such as in particular payment devices. Payment devices have conventionally been provided as a physical object—a plastic card with a particular form factor, known as a payment card (credit cards and debit cards are examples). These cards contain stored user information—generally some of this is printed and some is also stored digitally on a magnetic stripe, a chip that is either powered by a reader or by induction, or both. The printed information will often contain an account holder name, account and bank details, and in some but not all cases a PAN, or Primary Account Number, which is a standardised format for identifying a payment card (a PAN sequence number may also be used if there are multiple cards associated with a particular account). Individual payment card types however vary considerably as to what information is printed on the card, and how it is printed. Digitally stored information needs to be sufficient to allow the cardholder to use the payment card in an appropriate payment protocol—typically this will be an EMV payment protocol, following EMV standards for contact or contactless transactions as found at https://www.emvco.com/document-search/.

An increasingly attractive use model is for a cardholder to use a mobile banking application to transact using a virtual transaction device—here, a virtual payment card—through an appropriate application, such as a mobile payment application. Virtual payment cards may be provided, for example through an electronic wallet, which can be accessed by the mobile payment application for transaction purposes.

The process of provisioning a mobile phone or another computing device with a virtual card to correspond to a physical card can however be time consuming or otherwise onerous for the user. Typically this will require significant cardholder involvement in the setup process—in some cases, such as where limited or non-standard information is printed on the physical payment card, the cardholder may need to obtain information from more than one source in order to be able to perform this provisioning process.

The present disclosure has been devised to mitigate or overcome at least some of the above-mentioned problems.

### SUMMARY OF THE DISCLOSURE

According to an aspect of the present disclosure there is provided a method of provisioning a virtual transaction device to a computing device, wherein the method comprises the computing device: making a local wireless connection to a physical transaction device and obtaining account identifying information and issuer identifying information from the physical transaction device; using the issuer identifying information to connect over a network to a service acting for the issuer to indicate that a virtual transaction device is to be provisioned to the computing device for the account identified by the account identifying information; and interacting with the service to provision the virtual transaction device to the computing device for the account.

In embodiments, the computing device is the cardholder's mobile phone and the physical transaction device is a physical payment card.

In embodiments, the local wireless connection is an NFC connection. The connection may be initiated by proximity between the computing device and the physical transaction device, or may be initiated by a specific action, such as user interaction by the cardholder at the computing device, or by a physical action such as a “tap” (such as the “tap” between a payment card and a computing device such as a terminal to initiate a contactless transaction according to EMV protocols).

In embodiments, the account identifying information and the issuer identifying information are both provided by the PAN of the payment card. In a conventional PAN as used in systems employing EMV protocols, the first six digits of the PAN identify the card issuer. The remaining digits of the PAN are not an account number as such, but they do allow the issuer to reconcile the PAN with a specific user account of the cardholder.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the disclosure will now be described, by way of example only, with reference to the accompanying drawings, in which:

FIG. 1 is a schematic diagram illustrating a typical four-party model used in payment interactions between entities operating in a card scheme;

FIG. 2 is a schematic diagram illustrating the components used in an embodiment of the disclosure;

FIG. 3 shows schematically functional elements of a computing device adapted to carry out elements of the present disclosure;

FIG. 4 shows elements of a transaction infrastructure to support digitised payments from a mobile device in more detail; and

FIG. 5 is a flow diagram illustrating schematically steps in the performance of an embodiment of the disclosure.

### DETAILED DESCRIPTION

General and specific embodiments of the disclosure will be described below with reference to the Figures.

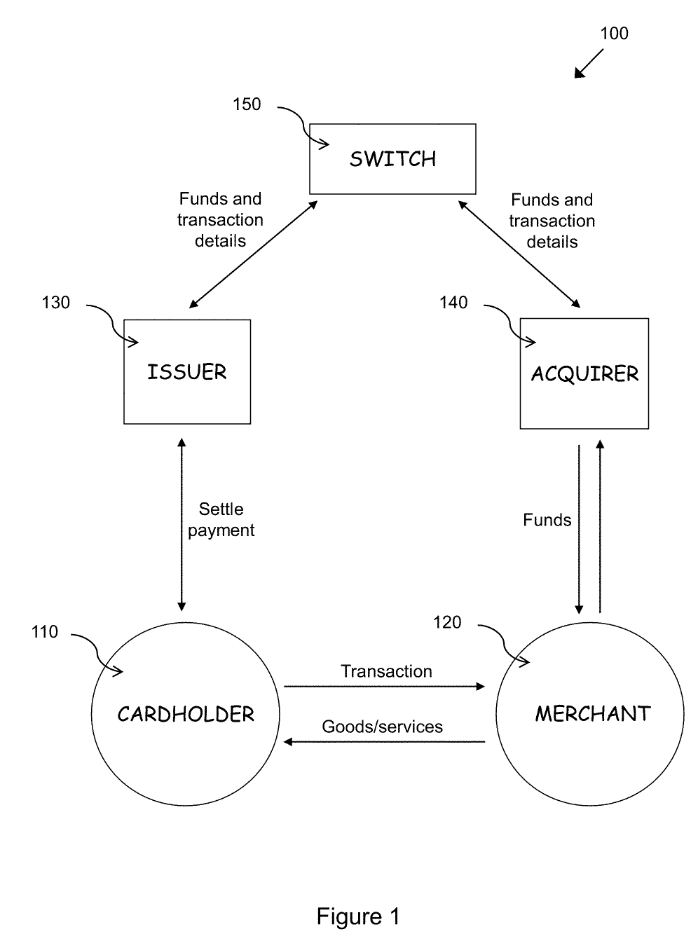

FIG. 1 is a schematic diagram of a typical four-party model or four-party transaction scheme. The diagram illustrates the entities present in the model and the interactions occurring between entities. Embodiments of the disclosure discussed below relate to implementation of the disclosure to provision a computing device with a payment card adapted to function in such a transaction scheme.

Normally, card schemes—payment networks linked to payment cards—are based on one of two models: a three-party model (adopted by American Express) or a four-party model (adopted by Visa and Mastercard). For the purposes of this document, the four-party model 100 is described in further detail below.

The four-party model may be used as a basis for the transaction network. For each transaction, the model comprises four entity types: cardholder 110, merchant 120, issuer 130 and acquirer 140. In this model, the cardholder 110 purchases goods or services from the merchant 120. The issuer 130 is the bank or any other financial institution that issued the card to the cardholder 110. The acquirer 140 provides services for card processing to the merchant 120.

The model also comprises a central switch 150—interactions between the issuer 130 and the acquirer 140 are routed via the switch 150. The switch 150 enables a merchant 120 associated with one particular bank (acquirer 140) to accept payment transactions from a cardholder 110 associated with a different bank (issuer 130).

A typical transaction between the entities in the four-party model can be divided into two main stages: authorisation and settlement. The cardholder 110 initiates a purchase of a good or service from the merchant 120 using their card. Details of the card and the transaction are sent to the issuer 130 via the acquirer 140 and the switch 150 to authorise the transaction. Should the transaction be considered abnormal by the issuer 130, the cardholder 110 may be required to undergo a verification process to verify their identity and the details of the transaction. Once the verification process is complete the transaction is authorised or denied.

On completion of the transaction between the cardholder 110 and the merchant 120, the transaction details are submitted by the merchant 120 to the acquirer 140 for settlement.

The transaction details are then routed to the relevant issuer 130 by the acquirer 140 via the switch 150. Upon receipt of these transaction details, the issuer 130 provides the settlement funds to the switch 150, which in turn forwards these funds to the merchant 120 via the acquirer 140.

Separately, the issuer 130 and the cardholder 110 settle the payment amount between them. In return, a service fee is paid to the acquirer 140 by the merchant 120 for each transaction, and an interchange fee is paid to the issuer 130 by the acquirer 140 in return for the settlement of funds.

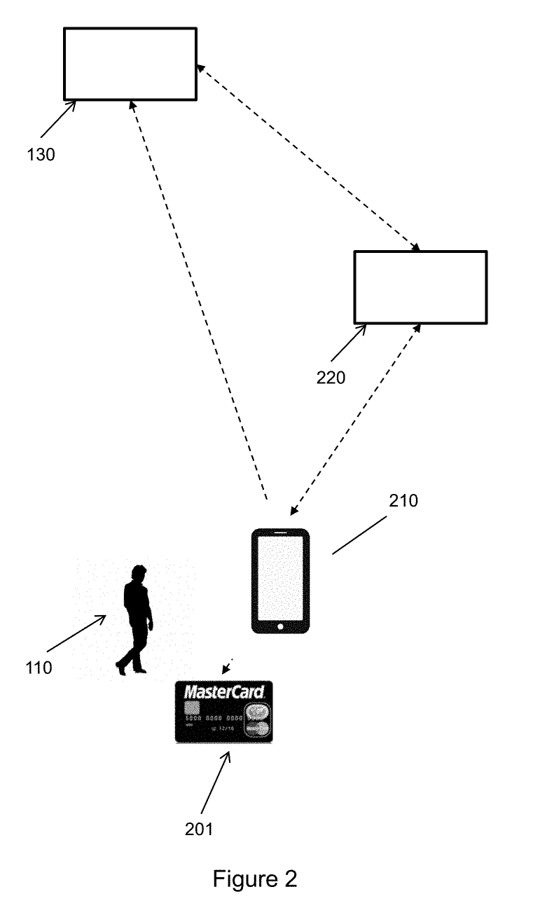

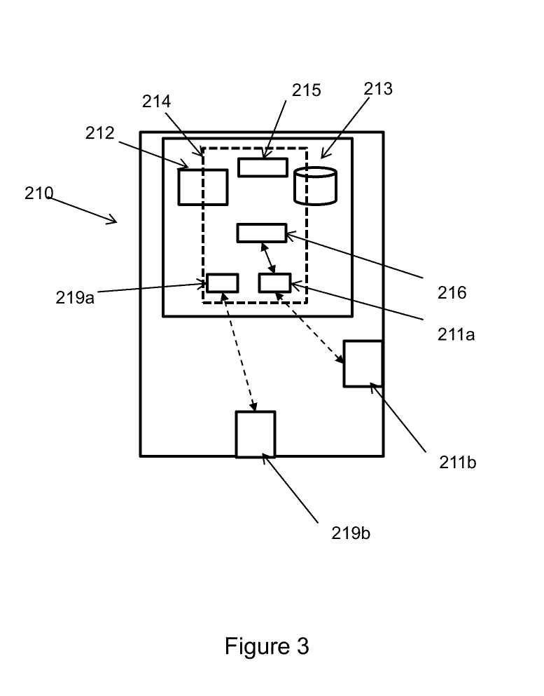

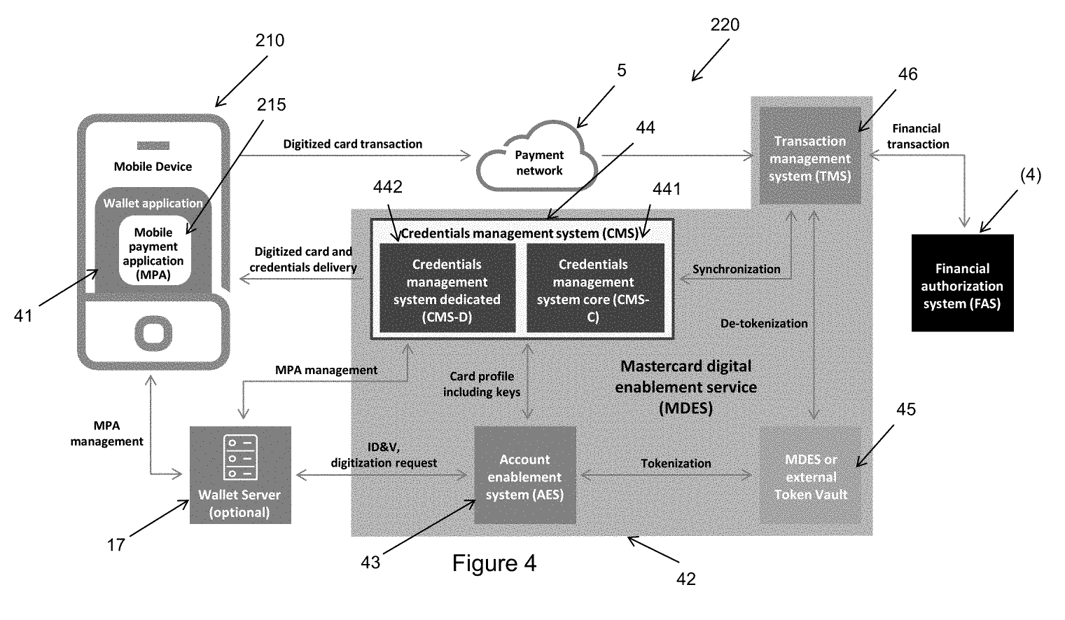

FIG. 2 illustrates schematically elements used in implementing an embodiment of the disclosure, with FIG. 3 and FIG. 4 respectively showing functional elements of a mobile phone 210 and a transaction infrastructure 220 respectively. The cardholder 110 is equipped with one or more physical payment cards 201 and a computing device, in this case a mobile telephone 210. As shown in FIG. 3, the computing device in this embodiment has a wireless communication capability 211 (shown as provided by a combination of NFC application software 211a and hardware 211b), here allowing the mobile computing device to communicate by NFC protocols and in embodiments also by 802.11 wireless networking technologies—this or another networking capability (such as cellular telephony capability 219—shown as provided by a combination of a telephony application 219a and hardware 219b) may be used to communicate with remote computing devices over an appropriate network connection. The computing device has a processor 212 and a memory 213, between them defining a computing environment 214 in which applications can run. In embodiments of the disclosure, these include a payment application 215 and a card reading application 216 communicating with the short range wireless communication capability 211. These two applications may be integrated together, or the card reading functionality may be provided by a separate application that either provides this functionality discretely or else includes this functionality for another purpose. An example of this latter type of application is xPAY (described at https://xpay-app.com/), which is an application that allows a general purpose computing device to be used as a point of sale terminal.

As indicated above, the computing device to be provisioned with a virtual card need not be a mobile phone. One possibility is for the provisioned computing device to be a wearable device, such as a smart watch or a fitness tracker. In such cases, the mobile phone 210 may in local network communication with the wearable device and used during the provisioning process, but with the virtual card actually provisioned to the wearable device.

FIG. 4 shows elements of a transaction infrastructure 220 to support digitised payments from a mobile device 210 in more detail. This Figure shows as a specific example the applicant's Mastercard Cloud Based Payment (MCBP) architecture—this is exemplary rather than specific to the invention, and illustrates how the architecture is used to support a mobile payment application 215 on a mobile device (such as smartphone 210)—here the mobile payment application 215 is shown as contained within a wallet application or digital wallet 41. Such a digital wallet 41 may communicate with a wallet server 17 to allow management of the mobile payment application, and it also can be used to request digitization of a payment card 6 to be used by the mobile device 210.

The Mastercard Digital Enablement Service (MDES) 42 performs a variety of functions to support mobile payments and digitized transactions. As indicated above, the MDES 42 is exemplary only, and is not essential to the invention—other embodiments may use digitisation, tokenisation and provisioning services associated with other transaction processing infrastructures, for example. The wallet server 17 is not a part of the MDES 42—and need not be present, for example if the mobile payment application 215 is not embedded within a digital wallet 41—but acts as an interface between the mobile device 11 and the MDES 42. The MDES 42 also mediates tokenised transactions so that they can be processed through the transaction scheme as for conventional card transactions. The following functional elements shown within the MDES 42: the Account Enablement System (AES) 43, the Credentials Management System (CMS) 44, the Token Vault 45, and the Transaction Management System (TMS) 46. These will be described briefly below.

The Account Enablement System (AES) 43 is used in card digitisation and user establishment. It will interact with the mobile payment application (here through the wallet server 17) for card digitisation requests, and will populate the Token Vault 45 on tokenisation and wil interact with the CMS 44 to establish a card profile with associated keys for digital use of the card.

The Credentials Management System (CMS) 44 supports management of cardholder credentials, and is a key system within the MDES 42. The core system 441 manages synchronisation with the transaction system as a whole through interaction with the TMS 46 and manages the channel to the AES 43. The dedicated system 442 provides delivery of necessary elements to the mobile payment application such as the digitized card and credentials and keys in the form needed for use. This system may also interact with the wallet server 17 for management of the mobile payment application.

The Token Vault 45—which is shown here as within the MDES 42, but which may be a separate element under separate control—is the repository for token information including the correspondence between a token and the associated card. In processing tokenised transactions, the MDES 42 will reference the Token Vault 45, and tokenisation of a card will result in creation of a new entry in the Token Vault 45.

Transaction Management System (TMS) 46 is used when processing tokenised transactions. If a transaction is identified by the transaction scheme as being tokenised, it is routed to the TMS 46 which detokenises the transaction by using the Token Vault 45. The detokenised transaction is then routed to the issuer (here represented by Financial Authorisation System 47) for authorisation in the conventional manner. The TMS 46 also interacts with the CMS 44 to ensure synchronisation in relation to the cardholder account and credentials.

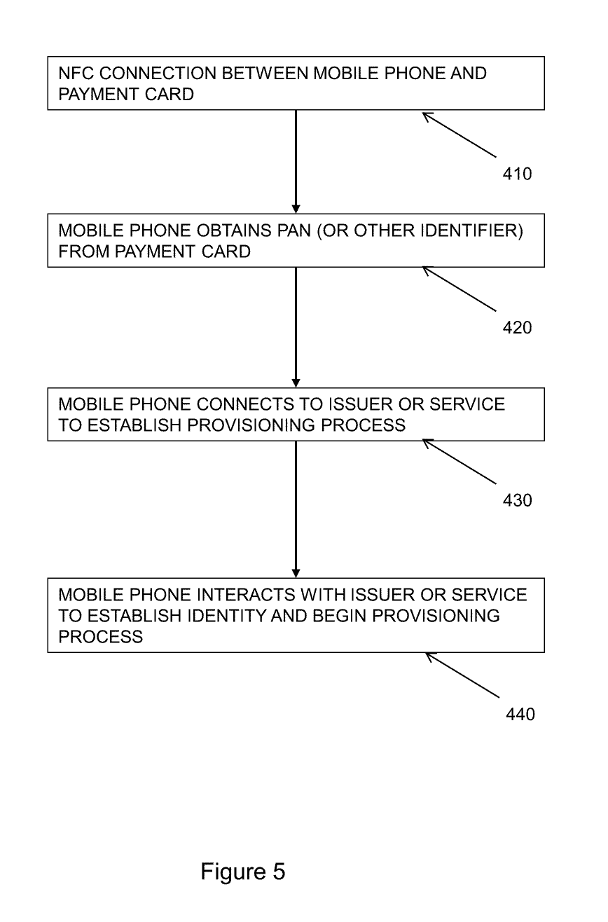

Operation of an embodiment of the disclosure is set out with reference to FIG. 5.

Firstly, an NFC connection is established between the mobile phone 210 and the payment card 201. This may be achieved in a number of ways. For example, if a discrete card reading application 216 is used (or an application with card reading functionality such as xPAY), this may be opened and a “tap” (a movement into close proximity between the mobile phone 210 and the payment card 201 for a short period of time, typically a few tenths of a second, as for contactless payment) made to initiate a connection and then exchange information. If xPAY is used, a new card enrolment process can be employed for this purpose. Alternatively, if the mobile payment application 215 on the mobile phone 210 has card reading functionality, this can be simply opened and a tap used to establish the information transfer.

Once the connection is established, the mobile phone 210 obtains 420 the PAN from the payment card 201. In principle, other identifiers may be used for this purpose, but there are advantages in using the PAN for this purpose as it uses a limited and standardised information set to provide issuer information and also account information—though the account information may be in a form where only the issuer and parties acting for the issuer could reconcile it with a specific account of the cardholder with the issuing bank. The numbering scheme for PANs is established by ISO/IEC 7812, which is implemented by EMV standards. The first six digits of the PAN forms the Issuer Identification Number (or IIN), which identifies the card issuer. The remaining digits provide account identifying information and a check digit.

Once the issuer has been identified, the mobile phone (automatically through whichever application has been launched, or with cardholder intervention) can be used to progress the provisioning process by making a connection 430 to the issuer, or a party acting on behalf of the issuer. This may be done through the mobile payment application 215, or through a discrete banking management application. This connection allows the issuer to be notified that a process of provisioning a virtual payment card to a cardholder's mobile phone has begun so that the mobile phone can be used as a payment device.

The issuer needs to establish 440 that the request to provision a virtual card is legitimate and authorised by the cardholder. To do this, the issuer (or the service acting for the issuer) needs to verify that the cardholder is present and that the cardholder approves the digitisation of the physical card. If the issuer has already been notified of the cardholder's telephone details on setup, or in a later update process when the cardholder has logged in to a management interface, then this can be done easily through interaction with the mobile phone. A two-factor authentication for the cardholder can easily be provided in this way by the possession of the phone by the cardholder (something the cardholder has) along with a successful log in step such as knowledge of the card PIN, login to the mobile banking application (something the cardholder knows), or a biometric measurement (something the cardholder is).

At this point the issuer and the mobile phone are in communication and it has been established what card is to be digitised as a virtual card on the mobile phone 210, what cardholder account with the issuer that this card relates to, and that the cardholder is verified as in control of the mobile phone and as approving the digitisation process. At this point, card digitisation can proceed in a conventional manner according to any card digitisation process used for that mobile payment application, for example using the tokenisation infrastructure set out in FIG. 4.

Many modifications may be made to the above examples without departing from the scope of the present disclosure as defined in the accompanying claims.

1. A method of provisioning a virtual transaction device to a computing device, wherein the method comprises the computing device:
making a local wireless connection to a physical transaction device and obtaining account identifying information and issuer identifying information from the physical transaction device;
using the issuer identifying information to connect over a network to a service acting for the issuer to indicate that a virtual transaction device is to be provisioned to the computing device for the account identified by the account identifying information; and
interacting with the service to provision the virtual transaction device to the computing device for the account.

2. The method of claim 1, wherein the computing device is a cardholder's mobile phone and the physical transaction device is a physical payment card.

3. The method of claim 2, wherein the local wireless connection is an NFC connection.

4. The method of claim 2, wherein the local wireless connection is initiated by proximity between the computing device and the physical transaction device.

5. The method of claim 2, wherein the local wireless connection is initiated by a specific action.

6. The method of claim 5, wherein the specific action is user interaction by the cardholder at the computing device

7. The method of claim 5, wherein the specific action is a tap of the payment card against the computing device.

8. The method of claim 2, wherein the account identifying information and the issuer identifying information are both provided by the PAN of the payment card.

9. A computing device comprising a processor, a memory, and wireless networking apparatus to support a local wireless connection wherein the computing device is programmed to provision a virtual transaction device to the computing device by:
making a local wireless connection to a physical transaction device and obtaining account identifying information and issuer identifying information from the physical transaction device;
using the issuer identifying information to connect over a network to a service acting for the issuer to indicate that a virtual transaction device is to be provisioned to the computing device for the account identified by the account identifying information; and
interacting with the service to provision the virtual transaction device to the computing device for the account.

10. The computing device of claim 9, wherein the computing device is the cardholder's mobile phone and the physical transaction device is a physical payment card.

11. The computing device of claim 10 wherein the local wireless connection is an NFC connection.

12. The computing device of claim 10, wherein the local wireless connection is initiated by proximity between the computing device and the physical transaction device.

13. The computing device of claim 10, wherein the local wireless connection is initiated by a specific action.

14. The computing device of claim 13, wherein the specific action is user interaction by the cardholder at the computing device

15. The computing device of claim 13, wherein the specific action is a tap of the payment card against the computing device.

16. The computing device of claim 10, wherein the account identifying information and the issuer identifying information are both provided by the PAN of the payment card.
